(19) United States
(12) Patent Application Publication
(10) Pub. No.: US 2018/0172852 A1
(43) Pub. Date: Jun. 21, 2018

(54) Dual-Scintillator Neutron-Gamma Detector

(71) Applicant: David Edward Newman, Poway, CA (US)

(72) Inventor: David Edward Newman, Poway, CA (US)

(21) Appl. No.: 15/462,647

(22) Filed: Mar. 17, 2017

Related U.S. Application Data
(60) Provisional application No. 62/436,013, filed on Dec. 19, 2016.
(60) Provisional application No. 62/443,700, filed on Jan. 7, 2017.

(51) Int. Cl. G01T 3/06; G01V 5/00

(52) U.S. Cl. CPC G01T 3/06; G01V 5/0008

(57) ABSTRACT

A versatile radiation detector comprises an extremely thin scintillator which is optically coupled to a different, much thicker scintillator that produces light pulses detectably different from the thin scintillator. Proximate to the thin scintillator is an extremely thin converter layer comprising boron or lithium. Neutron reactions in the converter generate ions that are detected in the thin scintillator, whereas gamma rays interact with the thick scintillator. Both scintillator light pulses travel through the thick scintillator as a light guide, and are detected in a light sensor. Numerous versions are disclosed for different applications, including gamma-blind, hydrogen-free, and multiple stacked configurations. The detector is economical and versatile, very well-suited for large-area inspection applications, highly effective in walk-through portal applications, and optimal for hand-held survey instrument products.

### CROSS REFERENCE TO RELATED APPLICATIONS

This application claims the benefit of U.S. Provisional Patent Application No. 62/436,013 entitled “Gamma-Blind Neutron Detector” and filed on Dec. 19, 2016, and U.S. Provisional Patent Application No. 62/443,700 entitled “Dual-Scintillator Radiation Detector” and filed on Jan. 7, 2017; the entire disclosures of which are incorporated by reference as part of the specification of this application.

### FIELD OF INVENTION

The invention relates to radiation detectors, and particularly to detectors that separately detect neutrons and gamma rays.

### BACKGROUND OF THE INVENTION

The US government has ordered that all cargo entering at border crossings and shipping ports must be scanned to detect radioactive materials such as nuclear bombs and radiological weapons. Although such weapons emit radiation such as gamma rays and neutrons, a clandestine weapon is likely to be heavily shielded, leaving little detectable signature. There is as yet no suitable detector for a well-shielded weapon.

High-energy neutrons from nuclear decays interact primarily by elastic or inelastic scattering from nuclei. Neutron elastic scattering from hydrogen, however, is purely elastic, and emits a recoil proton, while withdrawing energy from the neutron. Hence most high-energy neutron detectors rely on hydrogen as the recoil target.

Low-energy neutrons typically interact with matter in a neutron-capture reaction, wherein a nucleus absorbs the neutron and responsively emits one or more energetic ions and/or gamma rays. For example, a neutron may be captured by a boron-10 nucleus in the reaction ¹⁰B(n,α)⁷Li*, where α is an alpha particle or ⁴He ion. Likewise a neutron can be captured in a lithium nucleus as in the reaction ⁶Li(n,t)α, where t is a triton or ³H ion. The emitted neutron-capture ions typically have an energy of about 1-3 MeV. Such ions generally have a very high rate of energy deposition in matter, and thus a very short stopping range or stopping distance in most materials.

Gamma rays (“gammas”) interact with matter by electromagnetic processes including photoelectric absorption, Compton scattering, and pair production. Each of these processes generates one or more energetic electrons (positrons being treated as electrons herein). Such gamma-generated electrons typically have an energy of 0.2-2 MeV. Electrons in this energy range have a much lower rate of energy deposition than the neutron-generated ions, and thus have a much longer stopping range in most materials.

Prior-art radiation detectors are sufficient to detect unshielded radiological and nuclear weapons. But for a shielded weapon, a detector must be able to detect the small amount of radiation that leaks out through the shield, and must nearly surround the vehicle to obtain sufficient counts. Since prior-art detectors cover only a small fraction of the area around a truck trailer or shipping container, there is little chance of detecting a well-shielded nuclear or radiological weapon using prior-art detectors. Scaling up a prior-art detector array to provide sufficient coverage would be extremely expensive. In addition, most such systems rely on scarce elements such as ³He.

Increased sensitivity to small quantities of nuclear materials is also needed to detect contamination or theft at labs and other sites where nuclear materials are processed. A walk-through portal that sensitively detects neutron and gamma radiation from a worker's shoes, hair, toolbox, or pockets would prevent the risk of losses.

A new generation of compact, light-weight, low-power neutron and gamma detectors are needed for hand-held applications such as survey meters of the type used for secondary inspections in shipping containers or trucks for example.

What is needed, then, is a detector with high and selective detection efficiency, for high-energy and low-energy neutrons as well as gamma rays, suitable for large area scanning as well as compact light-weight instruments, not relying on scarce materials, and preferably having low cost.

### SUMMARY OF THE INVENTION

The invention is a detector comprising two different scintillators, arranged to detect low-energy neutrons by neutron-capture reactions, high-energy neutrons by proton recoil, and gamma rays by electromagnetic interactions. The invention is suitable for large area vehicle scanning applications as well as portal detection and small survey instruments. The materials are economical and do not involve toxins or rare/exotic/vanishing materials such as ³He.

The inventive detector comprises a series of separate but adjacent, substantially planar layers including an extremely thin neutron-reaction layer (the “converter”), a separate and extremely thin scintillator (the “thin-scintillator”), and a much thicker scintillator (the “thick-scintillator”), plus a light sensor. The converter is an extremely thin, substantially planar, layer of a material that captures low-energy neutrons and responsively emits energetic ions. Proximate to the converter is an extremely thin, substantially planar, thin-scintillator comprising material that emits a first light pulse when traversed by a charged particle such as an energetic ion. Coupled to the thin-scintillator is the thick-scintillator, which is a substantially planar transparent body that emits a second light pulse, different from the first light pulse, when traversed by a charged particle such as a Compton electron. The thick-scintillator is optically coupled to the thin-scintillator, so that the thick-scintillator receives light pulses from the thin-scintillator and carries both the first and second light pulses to the light sensor. The light sensor then produces electronic signals related to the light pulses, thereby providing information about the detected particle.

The thin-scintillator detects low-energy neutrons by neutron-capture reactions. The converter material, typically comprising either boron or lithium, captures low-energy neutrons and emits ions such as alpha or triton ions. The ions escape from the converter and enter the thin-scintillator, causing it to generate a characteristic first light pulse, which propagates through the thin- and thick-scintillators until reaching the light sensor or sensors.

The thick-scintillator detects gamma rays by electromagnetic interactions, which produce energetic electrons such as Compton electrons. The electrons cause the thick-scintillator to emit its characteristic second light pulse, different from the thin-scintillator light pulse. Both types of light pulses are detected in the sensor or sensors, which then produce an electronic signal related to the light pulses, thereby specifying which of the scintillators is active.

The thin-scintillator and the thick-scintillator produce distinct light pulses. The light pulses may differ in pulse shape or duration, in which case electronics can process the sensor signals and identify the two types of pulses. If the light pulses differ in wavelength, then the detector includes two light sensors coupled to two optical filters, with each filter selecting only the light from one of the scintillators. Thus the detector indicates whether a low-energy neutron or a gamma ray was detected.

The converter and the thin-scintillator are “thin” in that their thicknesses are related to the stopping range of the most penetrating neutron-capture ions, which is typically a few microns. The converter layer must have sufficient thickness to provide high neutron detection efficiency, but not so thick that the ions are unable to escape from the converter. As discussed in more detail below, the preferred range for the converter thickness is 0.2 to 2.0 times the ion stopping range, in the converter material, of the most penetrating ion from the neutron-capture reaction, with further limitations depending on the configuration.

The thin-scintillator is also thin. It must be thick enough to provide an unambiguous light pulse from a neutron-capture ion, but should also be as thin as possible so that gamma-generated electrons do not produce enough light in the thin-scintillator to mimic an ion track. Generally there is no need for the thin-scintillator to be thicker than the ion stopping range, because that is as far as the ions can go. The thin-scintillator thickness is preferably in the range of 0.1 to 1.0 times the ion stopping range, with the most preferred thickness being 0.2 times the ion stopping range.

The inventive converter and the thin-scintillator layers are preferably so thin that their lateral dimensions are much larger than their thicknesses. (The lateral dimensions of a layer are the dimensions orthogonal to the thickness, such as the width and length of the layer.) Typically the lateral dimensions of the converter are both at least 1000 times, and often 100,000 times, larger than the converter thickness. Likewise, the lateral dimensions of the thin-scintillator are both at least 1000 times, and often 100,000 times, larger than the thin-scintillator thickness. In contrast, the thick-scintillator is not “thin” as used herein; the thick-scintillator is typically at least 200 times as thick, and often 10,000 times as thick, as the thin-scintillator, so as to provide sufficient scintillation light to detect gamma rays and also to efficiently transport the light to the sensor.

The inventive converter and thin-scintillator are preferably planar layers, as opposed to coated fibers and the like. Planar layers are easier to make, more economical than complex forms, usually require less of the expensive isotopically-separated materials, and are more rugged than intermingled non-planar forms. Also, the scintillation light from both of the scintillators propagates with lower losses in a planar guide than through a multitude of intervening fibers or other obstructions. Planar layers enable placing a reflective layer between the converter and the thin scintillator, thereby substantially improving the light propagation, which would be difficult or impossible with fiber-like configurations. Finally, planar configurations are intrinsically scalable and thus are much more suitable for large-area applications such as vehicle inspection and walk-through portals.

The thin-scintillator and the converter are “proximate” to each other when the converter and the thin-scintillator are close enough together that the energetic ions can pass from the converter to the thin scintillator without substantial loss of energy in the intervening air. For a boron converter, the distance between the converter and the thin-scintillator is preferably no greater than 0.3 mm to limit energy losses of the alpha ion in air. For a lithium converter, the distance is preferably no greater than 2 mm, the larger limit being due to the higher range of the tritons. In both cases, the most preferred distance between the converter and the thin-scintillator is zero, that is, the converter is preferably in direct contact with the thin-scintillator (or in contact with a reflective coating, if present on the thin-scintillator).

The light sensor or sensors produce a first electronic signal responsive to a thin-scintillator light pulse, and a second electronic signal, different from the first electronic signal, responsive to a thick-scintillator light pulse. The first electronic signal indicates that a low-energy neutron has been captured in the converter and one of the energetic ions was detected in the thin-scintillator. Interpretation of the second electronic signal depends on the composition of the thick-scintillator. If the thick-scintillator includes hydrogen in its composition (“H-type”) then the thick-scintillator will respond to both gamma-generated electrons and recoil protons from n-p elastic scattering in the thick-scintillator. But if the thick-scintillator is substantially hydrogen-free (“non-H-type”) then there are no recoil protons, and the non-H-type thick-scintillator responds only to gamma rays. Thus an electronic signal characteristic of the thick-scintillator indicates that a gamma ray has been detected if the thick-scintillator is non-H-type, and indicates that either a gamma ray or a high-energy neutron has been detected if the thick-scintillator is H-type.

Some hydrogenous scintillators have a special fluor that produces distinct light pulses for highly-ionizing proton tracks, and different light pulses for lightly-ionizing tracks from electrons. In that case, further electronics can analyze the sensor output signals to determine whether the signal, from an H-type thick-scintillator with fluors sensitive to the ionization density, represents a gamma ray or a high-energy neutron.

In rare cases, both the thin-scintillator and the thick-scintillator may be triggered within a short time interval. For example, a recoil proton may pass from the thick-scintillator into the thin-scintillator, thereby generating both the thin-scintillator and thick-scintillator type pulses simultaneously. Or, a neutron may scatter on hydrogen in the thick-scintillator and then be captured by a nucleus in the converter, resulting in a thick-scintillator light pulse followed a thin-scintillator light pulse. As a third possibility, a boron converter may capture a neutron and then emit a de-excitation gamma which is detected in the thick-scintillator. In such cases, a composite signal is generated that includes a thick-scintillator light pulse and a thin-scintillator light pulse, all within a predetermined time window (a few microseconds typically). Such events are generally counted as neutron events since they all involve neutron interactions, or they may be simply ignored since they are relatively rare.

In many applications, particularly vehicle inspection applications, most of the radiation is gamma rays with very few neutrons. In such applications, it is usually inconsequential if the few proton-recoil events are counted as gammas, since the total number of counts is hardly affected. The thin-scintillator signal is accurately counted as a neutron signal, while the thick-scintillator signal is counted as a gamma signal with negligible error. This is especially relevant when a neutron moderator is provided to thermalize most of the high-energy neutrons before detection. In such applications the thick-scintillator may be made H-type, since plastic (hydrogenous) scintillators are usually more economical than non-H-type scintillators. Optionally, in applications requiring a more precise measure of the gamma flux, the thick-scintillator tally may be corrected for neutron scattering based on the number of low-energy neutron counts detected.

In other applications, particularly a survey meter that focuses on the neutron flux, the neutron and gamma detections must be strictly separated. In those cases a non-H-type composition for the thick-scintillators would be preferred. With a non-hydrogenous thick-scintillator, the thick-scintillator pulses represent gammas exclusively, while the thin-scintillator pulses represent neutrons exclusively. Even more preferred is a configuration that includes both hydrogenous and non-hydrogenous scintillators with separate sensors, thereby providing increased versatility and data on high-energy neutrons, low-energy neutrons, and gammas separately. Examples of such configurations, and suitable scintillators, are provided below.

In the inventive detector, the neutron-capture ions are preferably prevented from entering the thick-scintillator. If the thin-scintillator thickness is at least equal to the stopping range of the most penetrating ion, then this requirement is automatically met. But if the thin-scintillator thickness is less than the ion stopping range, then a transparent “barrier” layer may be added between the thin- and thick-scintillators to stop the ions before they reach the thick-scintillator. The sum of the thicknesses of the thin-scintillator plus the barrier should at least equal the maximum ion stopping range. The barrier must be optically well-coupled to both the thin- and thick-scintillator to enable light propagation.

In some embodiments, the thin-scintillator is a precast polymer film, which may be secured to the thick-scintillator by, for example, an adhesive layer. The adhesive layer can also serve as the barrier if sufficiently thick, thereby preventing any ions from reaching the thick-scintillator.

The thick-scintillator thickness is not related to the ion stopping range (unlike the converter and thin-scintillator thicknesses). The thick-scintillator must be thick enough to generate an unambiguous light pulse from a Compton electron, despite the low rate of energy deposition of such particles. The thick-scintillator must also be thick enough to efficiently convey the light from both scintillators to the sensor. Typically the thick-scintillator thickness is 5 mm to 26 mm. The lower end of this range would likely suffice for a small portable detector where the scintillator event is very close to the light sensor, while the higher values would be necessary for a large detector due to its longer light transmission distance.

The invention includes multiple configurations with different advantages. First, the “single-sided” configuration includes a single converter proximate to a single thin-scintillator which is optically coupled to a single thick-scintillator which is optically coupled to a light sensor (FIG. 1). An advantage of the single-sided configuration is simplicity since only one thin-scintillator deposition and one converter deposition would be required to produce the detector.

A second version is the “double-thick” configuration, in which the converter is flanked by two of the thin-scintillators, which are optically coupled to two of the thick-scintillators, which are viewed by one or more light sensors (FIG. 3). Thus the double-thick configuration comprises the single-sided configuration, plus a second thin-scintillator and a second thick-scintillator. The two thin-scintillators are both made from substantially the same thin-scintillator material and are both proximate to the same converter, on opposite sides. The two thick-scintillators are both made from the same thick-scintillator material, which is different from the thin-scintillator material, and each thick-scintillator is optically coupled to exactly one of the thin-scintillators. The double-thick configuration provides higher neutron detection efficiency while using only a single converter.

A third version is the “double-converter” configuration comprising the single-sided configuration plus a second thin-scintillator and a second converter. The thick-scintillator is flanked by the two thin-scintillators, and the two converters are on the outside, proximate to the two thin-scintillators (FIG. 4). The two thin-scintillators are optically coupled to the sole thick-scintillator, so that the thick-scintillator serves as a light guide for light from all three scintillators. Preferably the two thin-scintillators comprise substantially the same thin-scintillator material, and the two converters include substantially the same neutron-capture material. The double-converter configuration offers the advantage of economy since it provides high neutron detection efficiency while using just a single thick-scintillator.

A fourth version is a “gamma-blind” double-thick configuration, comprising a central converter, flanked by two thin-scintillators which are optically coupled to two light guides. One of the light guides is made from the thick-scintillator material, while the other light guide is a non-scintillating transparent body (FIG. 5). There are two light sensors. A first sensor is attached to the thick-scintillator and a second light sensor is attached to the non-scintillating light guide. Both sensors detect low-energy neutrons according to ions in the respective thin-scintillators viewed by each of the sensors. The first sensor, viewing the thick-scintillator, also registers gamma ray events, and possibly high-energy neutron events if the thick-scintillator is hydrogenous. The second sensor, however, is “gamma-blind” in that it has essentially zero interference from gamma ray backgrounds, since it views only the thin-scintillator and a non-scintillating light guide, neither of which produce a detectable gamma ray signature. Thus the sensor viewing the thick-scintillator provides a composite signal from neutrons and gammas, while the sensor viewing the non-scintillating light guide detects only low-energy neutrons, thereby providing an exceptionally clean neutron signal with no gamma background at all.

A fifth version of the inventive detector is the “H-non-H” configuration. Here a central converter is flanked by two thin-scintillators. Two thick-scintillators which are coupled to the thin-scintillators, and are viewed by two light sensors. However, one of the thick-scintillators includes hydrogen in its composition, while the other thick-scintillator comprises substantially no hydrogen. The H-type thick-scintillator responds to gamma ray interactions and proton recoil events equally, whereas the non-H-type thick-scintillator responds only to gamma rays. Thus the H-non-H configuration provides a first sensor, viewing the H-type thick-scintillator, that detects low-energy neutrons plus gammas and high-energy neutron recoil events, while the second sensor, viewing the non-H-type thick-scintillator, detects low-energy neutrons and gammas only, with no interference from high-energy neutrons.

The invention further includes a “stack” assembly comprising multiple detectors arranged in sequence (FIG. 6). The stack provides increased detection efficiency and other advantages as discussed below. The inventive stack comprises a plurality of converters, a plurality of thick-scintillators, and a plurality of thin-scintillators. Each thin-scintillator is proximate to exactly one of the converters and is optically coupled to exactly one of the thick-scintillators. Each converter is proximate to one or two of the thin-scintillators, and each thick-scintillator is optically coupled to one or two of the thin-scintillators. Each thick-scintillator is optically coupled to at least one of the light sensors, and each light sensor is optically coupled to at least one of the thick-scintillators. Thus each thin-scintillator detects the ions from one of the converters, and each thick-scintillator in the stack conveys light from itself plus one or two of the thin-scintillators to the sensor.

The stack may further include one or more non-scintillating light guides, each of which is optically coupled to either one or two of the thin-scintillators (FIG. 8). Also, the stack may include both H-type and non-H-type thick-scintillators for further separation of neutron and gamma information.

The inventive detector may include a reflective layer between the converter and the thin-scintillator, to enhance the light transmission (FIG. 2). Often the converter material has poor reflective properties or is not sufficiently smooth or has other optical defects. Therefore, a very thin coating of reflective material, such as aluminum or gold, may be applied either to the converter or to the thin-scintillator. The reflective layer must be sufficiently thin that it does not substantially impede the energetic ions from entering the thin-scintillator. For example, the reflector may be aluminum with a thickness of 20 to 200 nm, which is sufficient to form an opaque reflective layer but not so thick that the energetic ions are substantially impeded.

In some embodiments, the converter comprises a powder. Powders are easy to deposit without damaging the fragile underlying layers. However, powders typically have poor light reflection properties. Therefore it is strongly recommended that a reflective layer be deposited on the thin-scintillator before the powder converter is applied (FIG. 9).

The invention may include a moderator to slow down or moderate high-energy neutrons. Neutron-capture cross sections are generally much larger for low-energy neutrons than for high-energy neutrons. The most effective moderators contain large amounts of hydrogen, such as water or oil or a polymer, so that the neutrons are moderated by multiple elastic n-p collisions. The invention can include a hydrogenous moderator material, preferably with an area comparable to the detector area, and preferably positioned near the detector so that the low-energy neutrons are likely to drift from the moderator into the detector (FIG. 2). The thick-scintillator may also serve as a moderator if it comprises a hydrogenous material.

The thin-scintillator and the thick-scintillator are different materials with different light pulse properties, such as different pulse durations or different wavelengths. If the two scintillators differ in pulse shape or duration, their light pulses can be discriminated by electronics that process the light sensor output signals. If the two scintillators differ in the wavelength of the light, then at least two light sensors are required, each coupled to a different optical filter, and each filter being configured to admit only the light from one of the scintillators.

The invention includes a method for fabricating the detector as follows. A thick-scintillator is provided, comprising a transparent planar scintillating body. A thin-scintillator, comprising a scintillator different from the thick-scintillator, is attached to or deposited on the thick-scintillator, thereby optically coupling the thin-scintillator to the thick-scintillator. Then a converter layer, comprising boron or lithium, is deposited on the thin-scintillator, or otherwise arranged to be in close proximity to the thin-scintillator, so that neutron-capture ions can escape from the converter and enter the thin-scintillator. Then a light sensor is attached to the thick-scintillator, optionally including a light funnel. The light sensor is configured to produce electronic signals related to the scintillator light, so that the electronic signals indicate which of the scintillators is active. The entire detector is then wrapped in a light-tight wrap.

As used herein, a material is “deposited” on a surface when the material is added to the existing surface by any means, including vapor-phase deposition (such as CVD, sputtering, evaporative deposition), liquid-phase deposition (from melt, solution, slurry, spin-cast or the like), and solid-phase deposition (powder deposition with optional adhesive or binder) as well as attaching a pre-existing solid layer to the surface (such as a polymer film or a metallic foil, with or without adhesive).

For the inventive double-thick configuration, the method comprises: providing a first thick-scintillator, and depositing a first thin-scintillator on the first thick-scintillator. Then the converter material is deposited on the first thin-scintillator. A second thin-scintillator is then deposited on the converter, and a second thick-scintillator is positioned over the second thin-scintillator and optically coupled to the second thin-scintillator using, perhaps, optical grease or epoxy. Then the thick-scintillators are coupled to light sensors. An alternative method for the double-thick configuration begins with the first thin-scintillator deposited on the first thick-scintillator and the converter deposited on the first thin-scintillator, but then the second thin-scintillator is deposited on the second thick-scintillator (instead of depositing it on the converter). Then the two subassemblies are pressed together with the converter proximate to both of the thin-scintillators. As a third alternative, just half of the converter can be deposited on each side. In either case, the thin-scintillators must be optically well coupled to the adjacent thick-scintillator when finally assembled. If light-reflecting layers are needed, they may be deposited on the thin-scintillators before the converter is laid down.

The thin-scintillator may be deposited using, for example, thermal vapor deposition or chemical vapor deposition (such as CVD, MOCVD, and the like) or solvent (evaporative) deposition, or any other deposition procedure so long as the thin-scintillator layer has the right thickness. Alternatively, the thin-scintillator could be precast in film form, and then attached to the thick-scintillator surface by an adhesive or the like. As a further option, the thin-scintillator layer may be applied to a transparent non-scintillating protective layer (that is, the barrier) that can withstand the chemical and thermal stresses of the deposition, and then the protective layer (with the thin-scintillator attached) is applied to the thick-scintillator.

The converter material may be deposited on the thin-scintillator, using any of the deposition procedures listed above, or powder deposition (with optional binder or adhesive), or other procedure appropriate to the converter material. In the single-sided and double-converter configurations, the converter material remains exposed; therefore an optional protective cover may be affixed over each converter after deposition. However this is not an issue in the double-thick and stack configurations, since the subsequent layers encase the converters.

The invention provides many advantages over prior art. Because the inventive thin-scintillator is completely separate from the converter, the two materials can be optimized separately in the inventive detector. This avoids all of the interference problems that prior-art systems with intermingled converter-scintillator inevitably suffer, including poor optical properties and quenching. The inventive detectors have no such defect. The inventive converter layer can be optimized at will, so long as it is thin enough to allow the energetic ions to escape. The inventive thin-scintillators can be designed at will, so long as they are thin enough that gamma-generated electrons and background particles produce negligible light in the thin layers. And of course there is no quenching or other incompatibility between the thin-scintillator, thick-scintillator, and converter materials, since they are all in separate layers.

Secondly, the invention enables a wide range of versatile configurations that provide different information as needed for each application. The double-thick version of the invention has a big advantage since the neutron-generated ions can be detected from both sides of the converter material. All of the inventive detector configurations make it easy to add a reflective layer between the converter material and the thin-scintillators, thereby ensuring that the light transmission is not degraded by the adjacent converter material. Prior-art detectors that use scintillators blended with converter materials have no such capability.

The double-converter version of the invention has the advantage of simplicity and economy since it includes only one central thick-scintillator light guide, with the thin layers deposited on both sides. The gamma-blind configuration provides an extremely background-free measure of the low-energy neutron flux, a major advantage for many weapon inspection applications. The H-non-H configuration provides separate measurements for low-energy neutrons, gamma rays, and mixed radiation in separate sensors with separate pulse shapes.

Thirdly, the inventive detector is easily scaled from small dosimeter-size detectors to arbitrarily large sizes. Prior-art multi-radiation detectors of the scintillation type scale poorly, due to self-absorption of the scintillation light or severe gamma cross-talk or both. Prior-art neutron sensors based on proportional counters are not scalable at all since, for a large inspection system, a huge number of prior-art detector elements would be needed. Proportional detectors are intrinsically one-dimensional, while the inventive detector is intrinsically two-dimensional. Thus the inventive detector enables full-surround neutron and gamma ray inspection of shipping containers, trucks, and railcars for the first time.

The fourth major advantage of the invention is that it is very economical. The inventive detector uses only a microscopic amount of the expensive thin-scintillator material and isotopically separated converter materials. In fact, it works well even if the converter is made from natural boron or lithium compounds. Where prior detectors require large volumes of expensive inorganic scintillator or large amounts of ³He, the inventive detector can be assembled from ordinary low-cost plastic or glass scintillator sheets with just a micron-thin deposit of a different thin-scintillator. Many critical applications, previously deemed economically unfeasible, may now be addressed with the new low-cost system.

### BRIEF DESCRIPTION OF THE FIGURES

FIG. 1 is a cross-sectional view of an embodiment of the inventive detector in the single-sided configuration. Also shown is a neutron, an emitted ion, and the generated scintillation light. The sketch is not to scale; the thin-scintillator and the converter layer are greatly exaggerated in the sketch to show detail.

FIG. 2 is a view of the detector of FIG. 1 but with a reflective layer on the thin-scintillator, a transparent barrier/protective layer on the thick scintillator, a moderator for enhancing the low energy neutron flux, and dual sensors. A gamma ray interaction is shown. (Not to scale.)

FIG. 3 is a sketch of the inventive detector in a double-thick configuration, with two of the thick-scintillator light guides. (Not to scale.)

FIG. 4 is a sketch of the inventive detector in the double-converter configuration with two converters, proximate to two of the thin-scintillators, both feeding light into a single thick-scintillator light guide. Also, the scintillators differ in this example in their wavelengths, and thus a pair of optical filters are added to discriminate the two light pulses. (Not to scale.)

FIG. 5 is a sketch of the inventive double-thick detector but with one thick-scintillator and one non-scintillating light guide, which provides a gamma-blind neutron detection channel. (Not to scale.)

FIG. 6 is a sketch of a stack of four double-thick detectors according to the invention. (Not to scale.)

FIG. 7 is a sketch of the inventive stack of detectors, but with each of the thick-scintillators being shared between two adjacent converter layers. Two sensor arrangements are shown. (Not to scale.)

FIG. 8 is a sketch of the inventive detector stack, but here the thick-scintillators are alternated with non-scintillating light guides, to provide a separate measurement of pure neutron events with extremely low gamma interference. (Not to scale.)

FIG. 9 is an exploded cross-section sketch of the inventive detector, double-converter configuration, with two powder converters and optional protective covers. (Not to scale.)

FIG. 10 is an exploded assembly sketch of the inventive single-sided configuration with a precast film-type thin-scintillator, and with the converter being deposited on a backing plate before assembly. (Not to scale.)

FIG. 11 is a flowchart showing steps of a method to fabricate a detector according to the invention, double-thick configuration, with pulse shape discrimination assumed.

FIG. 12 is a flowchart showing steps of a method to fabricate the inventive detector, double-converter configuration, with a powder converter.

### DETAILED DESCRIPTION OF INVENTION

Two key features of the invention are the extreme thinness of the converter, and the extreme thinness of the thin-scintillator. The converter thinness is important to allow the ions to escape from the converter so they can be counted in the thin-scintillator. The thin-scintillator thinness is important to prevent gamma ray events from generating much thin-scintillator light and being counted as neutron-capture events. Gamma-generated electrons and cosmic rays produce very little light in passing through the thin-scintillator, due to their low rate of energy deposition and the extreme thinness of the thin-scintillator. Neutron-capture ions, on the other hand, generate a huge light pulse in the thin-scintillator due to their high ionization density and short stopping range.

Gamma ray events are rejected according to pulse height, wherein pulses below a certain threshold are rejected by electronics. Alternatively, pulse area or total charge or other feature related to the light may be employed for this purpose. By this means, the thin-scintillator light pulses indicate low-energy neutron events exclusively. The thick-scintillator, on the other hand, is thick enough to produce a readily detectable pulse from Compton electrons and the like. Thus if the thin-scintillator is thin enough, gamma rays generate only thick-scintillator light pulses exclusively, while low-energy neutrons generate only thin-scintillator light pulses exclusively. In addition, the thick-scintillator detects high-energy neutrons by elastic n-p scattering, if the thick-scintillator includes hydrogen, in which case the thick-scintillator pulses indicate either a gamma or high-energy neutron event. But if the thick-scintillator is hydrogen-free, then the thick-scintillator pulses indicate gamma rays exclusively (aside from an occasional cosmic ray muon, which can usually be ignored or corrected for as an unchanging background).

The inventive converter material is any material that captures neutrons and responsively emits energetic ions such as alpha and triton ions. The converter material may comprise boron, preferably boron metal, and more preferably enriched in ¹⁰B which has a large neutron capture cross-section and emits an alpha particle. The energy of the alpha depends on whether the daughter nucleus is in the ground or excited state. The maximum alpha energy is 1.78 MeV, which will be assumed for calculations herein. An alpha particle with this much kinetic energy has a stopping range in boron of 1.14 mg/cm² which corresponds to about 5 microns (assuming the beta-rhombohedral phase). The daughter ⁷Li* ion stops in less than 1 micron and usually remains in the converter layer. (Stopping ranges and layer thicknesses are given herein as areal-density units such as milligrams per square centimeter or mg/cm² since they are more precise and more versatile than distance units such as microns. In some cases the corresponding distance units are also given, if the density is known.)

The converter material could alternatively comprise lithium, preferably a stable compound such as LiF, and more preferably enriched in ⁶Li which captures a neutron and emits a triton and an alpha particle. The most penetrating ion is the triton with 2.73 MeV, which has a stopping range of 8.61 mg/cm² in LiF, or about 33 microns at full density of 2.635 g/cm². The daughter alpha typically stops in about 6 microns.

The converter layer is preferably thick enough to provide a high neutron capture probability, yet is sufficiently thin that the energetic ions have a high likelihood of escaping from the converter layer and entering one of the thin-scintillators. In a multi-converter stack configuration, an additional consideration is the shading (blocking) of one converter by another, which has the effect of lowering the optimal thickness by a factor that depends on the number of layers and other factors. Simulations show that, for a single detector, the converter efficiency is optimized with a converter thickness of 0.9 times the stopping distance of the most-penetrating ion from the neutron-capture reaction, and that an acceptable range of thicknesses, corresponding to about 80% of the optimal efficiency, is 0.5 to 2.0 times the stopping range of the most penetrating neutron-capture ion. Values below 0.5 tend to have low converter efficiency due to insufficient reaction material, while values above 2.0 tend to self-absorb most ions. Here the stopping range is calculated in the converter material, and the converter efficiency is defined as the number of ions exiting from either side of the converter divided by the number of incident thermal neutrons.

For a multi-converter stack configuration, the optimal thickness for converters is less than for a single isolated detector, because the stacked converters tend to obscure or “shadow” each other. For a multi-layer stack, the preferred converter thickness is about 0.2 to 0.5 times the stopping range of the most penetrating ion, depending on the number of layers and other factors. In general, covering both the single detector case and the stack configurations, the preferred range for the converter thickness is 0.2 to 2.0 times the ion stopping range. Artisans may further optimize the converter thickness for their particular application using a program such as MCNP.

To consider a specific example, a single isolated detector may have a converter comprising boron. The optimal thickness of the converter layer is 0.9 times the most penetrating ion range, or about 1.03 mg/cm², which is about 4.4 microns if solid. Alternatively, the converter thickness may be about 0.5 to 2.0 times the ion stopping range which corresponds to 80% or higher converter efficiency, or 0.57 to 2.3 mg/cm² assuming pure boron metal.

Alternatively, the converter could be LiF, in which case the most penetrating ion is the triton, and then the optimal thickness of the LiF converter layer would be about 7.8 mg/cm² or about 29 microns assuming full density. The 80% efficiency range corresponds to 4.3 to 17 mg/cm². The optimal thickness for a lithium converter is larger than for a boron converter because the stopping range of the triton from lithium is larger than the average stopping range of alphas from boron.

For detectors with other converter compounds, such as BN or B₄C or LiO or Li metal, artisans can derive the optimal and preferred converter thickness values by adapting the disclosed example calculations with standard range tables for the actual converter composition. In stacked arrays, the optimal converter thickness is typically about half of the single-detector values, to minimize shadowing. To derive the optimum converter thickness for a particular stack design, artisans can run a program such as MCNP with the actual number of layers, and vary the converter thickness in the simulation to find the thickness that provides the maximum number of detected ions per incident neutron.

The thick-scintillator material may be any scintillator that is transparent to its own light and to the thin-scintillator light. Also, the thick-scintillator must not include lithium or boron or other nuclei that have a large neutron reaction cross section, since any neutron reactions would produce an interfering signal. The thick-scintillator material may be hydrogenous or non-hydrogenous, depending whether the application calls for detecting the high-energy neutrons. Ordinary PVT-based plastic scintillator is an economical hydrogenous thick-scintillator, although other polymer-type scintillators would serve. For a hydrogen-free thick-scintillator, activated glass is an option, provided that it does not contain added lithium or boron. For the non-scintillating light guide option, a simple acrylic or styrene or carbonate sheet would be an economical choice.

The thin-scintillator is any scintillator that produces a light pulse with a shape or duration or wavelength or other detectable light pulse feature which is different from that of the thick-scintillator. The thin-scintillator may be in the form of a thin deposit or a precast film. It may be a plastic or other organic compound. Or, the thin-scintillator may be an inorganic layer, in which case it is preferably non-hygroscopic material such as CaF₂. CaF₂ has a pulse duration of 900 ns, which is easily discriminated from the 2-5 ns pulse duration from most plastic scintillators, and also from the 50-100 ns pulse width typical of glass scintillators.

The thin-scintillator could comprise ZnS(Ag), which has the advantage of being nearly unresponsive to lightly-ionizing tracks such as Compton electrons, but unfortunately ZnS is not transparent to its own light. It is possible that high-purity CVD-deposited ZnS layers may be sufficiently transparent, in which case ZnS may be considered with advantage, although some development may be needed. On the other hand, the thinness of the thin-scintillator layer virtually eliminates gamma rays in the thin-scintillator signal regardless of the type of scintillator, so the special gamma-rejection feature of ZnS may not be necessary.

As a further alternative, the thin-scintillator could comprise a hygroscopic scintillator such as NaI or CsI, provided that the final detector is configured to isolate the thin-scintillator layer from environmental moisture to prevent degradation.

As a further option, both the thin-scintillator and the thick-scintillator could be plastic scintillators, but with one of them having a special long-duration fluor that produces 250-300 ns light pulses, while the other scintillator uses one of the fast 2-5 ns fluors. An all-plastic detector would be economical and relatively easy to manufacture in large areas. However, most organic scintillators have a saturation effect such that the photon productivity (photons per keV deposited) is higher for lightly-ionizing particles than for intensely-ionizing ions. This would somewhat reduce the contrast between ion events and electron events in the thin-scintillator. CaF₂ and other inorganics usually do not have this saturation effect. Nevertheless, most plastic scintillators still produce plenty of light, even with the saturation effect, to discriminate electrons and ions in the thin-scintillator, so long as the preferred thickness ranges are followed as disclosed herein.

The thin-scintillator may be thick enough to stop all the ions, in which case the thin-scintillator thickness is simply 1.0 times the ion stopping range (ignoring straggling). Most ions do not penetrate nearly that far. On average, each ion will have lost about half of its initial energy in the converter before entering the thin-scintillator. Also, the ion usually does not enter the thin-scintillator orthogonally, but on average is traveling at an angle of about 30 degrees to the plane of the thin-scintillator. The penetration distance is thus about 0.5×sin(30)=0.25 times the full-energy ion stopping range in the thin-scintillator material. More detailed simulations are largely in agreement with this rough estimate. Consequently, the thin-scintillator can be substantially thinner than the full maximum ion stopping range, and still detect the ions with high efficiency.

In most embodiments, the scintillation pulse is detected only if its amplitude or total charge exceeds a particular electronic threshold, which commonly is about one-tenth of the amplitude of a full-energy ion in the thin-scintillator. Setting the threshold lower tends to risk counting occasional gammas as neutron events, while higher settings would throw away some valid neutron events. With that limitation, the preferred range for the thin-scintillator thickness is 0.1 to 1.0 times the stopping range of the most penetrating ion from the neutron-capture reaction, the stopping range being taken in the thin-scintillator material. The most-preferred value is 0.2 time that stopping range. The preferred values correspond to a scintillator detection efficiency (number of light pulses above threshold divided by number of ions escaping from converter) of at least 80%. Also, as mentioned, a transparent non-scintillating barrier may be added between the thin-scintillator and the thick-scintillator to ensure no ions reach the thick-scintillator.

To consider a specific example, the converter may comprise lithium and the thin-scintillator may be CaF₂ with a thickness of 50 microns, or about 13 mg/cm² at a density of 2.635 g/cm³. The light production of CaF₂ is about 24 photons per keV of energy deposited, for both electrons and ions. A Compton electron with 1 MeV energy would pass through the thin-scintillator, depositing about 2 keV per mg/cm², or about 26 keV in the thin-scintillator, which would produce 24×26=624 photons. On the other hand, the triton from the lithium capture reaction has initially 2.73 MeV, and assuming it loses half of the energy in the converter and the rest in the thin-scintillator, the ion would produce about 33,000 photons, which is over 50 times larger than the electron light pulse. Thus a gamma event produces a signal at the sensor only 2% as large as an average neutron event. Therefore gamma events in the thin-scintillator are easily rejected on pulse amplitude alone.

Likewise for the case of a boron converter, where the thin-scintillator thickness is about 1 mg/cm². The same calculation shows that the ratio of signal amplitudes is even greater, the ion pulse being 372 times larger than the gamma signal. These pulse height ratios are large enough that gamma events would essentially never be counted as neutron events in the thin-scintillator. The examples illustrate a key advantage of the invention with a planar thin-scintillator having a thickness related to the ion stopping distance: gamma rays are detected exclusively in the thick-scintillator, and low-energy neutrons are detected exclusively in the thin-scintillator, with no crossover.

The thick-scintillators, if they comprise an organic or other hydrogen-rich material, may also serve as neutron moderators. The neutron-capture cross section in the converter material is strongly dependent on the energy of the neutron. Slow or thermalized neutrons have a very large capture cross-section in boron or lithium, whereas high-energy neutrons are likely to pass through the thin converter material without scattering or reacting at all. In the thick-scintillator, on the other hand, the high-energy neutrons may be slowed or thermalized by scattering in the thick-scintillator, if it contains hydrogen. A hydrogenous thick-scintillator thereby increases the neutron reaction probability in the converter layer by moderating high-energy neutrons.

The light-reflecting properties of the converter material may be problematic. Typically the light from both scintillators is propagated by reflecting repeatedly between the outer surfaces of the thick-scintillator and the thin-scintillator before reaching the light sensor. If the converter material is in optical contact with the thin-scintillator, the light would also impinge multiple times against the converter material and could be absorbed or scattered if the converter layer is not sufficiently reflecting. Therefore, the converter layer or the thin-scintillator surface may be coated by a light-reflecting material, such as aluminum or gold. The light-reflecting layer must be extremely thin so that the energetic ions can pass through it into the thin-scintillator.

The inventive detector stack configuration, with multiple detectors arranged in sequence, provides increased detection efficiency. The stack also indicates whether the incident neutron or gamma ray is low or high energy according to which module of the stack was triggered. Thermalized neutrons are likely to be captured in the first converter layer that they encounter, due to the large capture cross-section at low energies. Energetic neutrons, in contrast, are likely to penetrate multiple layers, scatter within the stack, and then finally are detected deep in the stack. Similarly, low-energy gammas are also more likely to interact in the first few layers than high-energy gammas, due to the photoelectric cross section increasing at low photon energies.

In some applications, such as vehicle and container inspection applications, an array of detectors may be arranged like a tunnel, almost surrounding the item being inspected, to maximize the probability of detecting any escaping radiation. Radiation coming from the environment would interact in the outermost layers of the array, while radiation from the inspection item would more likely be detected in the innermost layers facing the item.

The inventive detector includes one or more light sensors optically coupled to the thick-scintillator. The light sensor thereby detects light pulses from both the thick-scintillator and thin-scintillators. The light sensor may be a photomultiplier tube, a multichannel plate detector, a photodiode, an avalanche photodiode, or any other light-sensitive device that generates an output electronic signal related to the light. When multiple light sensors view the same thick-scintillator, the lateral position of the neutron reaction may be determined by comparing the arrival times or the pulse amplitudes of the scintillation light at the various light sensors. For improved light collection and better uniformity, a transparent plastic form such as a light funnel may be coupled to the thick-scintillator, and the light sensor may be coupled to the light funnel.

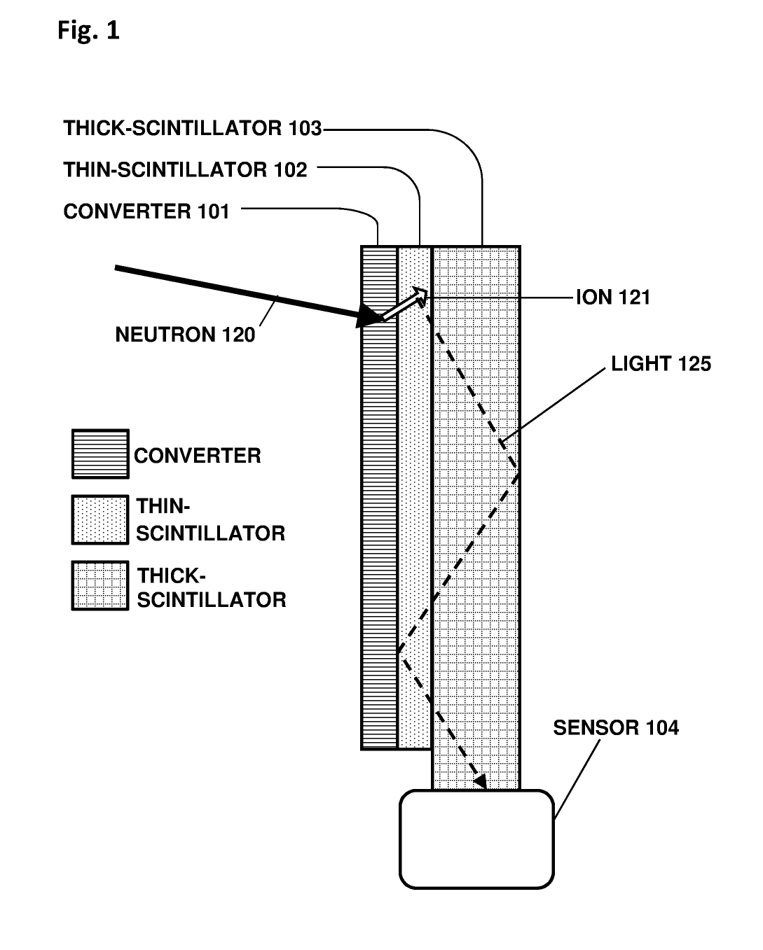

Turning now to the figures, FIG. 1 shows a version of the inventive detector in transverse section. The thin layers are greatly exaggerated in this sketch to show detail. If an actual detector were drawn to scale, the thin layers would be so fine as to be invisible on this scale.

The detector comprises a thin converter layer 101 shown in horizontal hash, a thin-scintillator 102 in light stipple, a thick-scintillator 103 in cross-hash, and a light sensor 104. (All the figures use the same patterning for the same materials.) The thick-scintillator 103 is not thin; it is a normal plastic scintillator plate on which the extremely thin layers 101 and 102 are deposited. A neutron 120, shown as a solid arrow, arrives from the left and is captured by a nucleus in the converter layer 101, thereby generating an energetic ion 121 shown as a hollow arrow, which escapes from the converter layer 101 and travels in the thin-scintillator 102. The thin-scintillator 102 then emits light 125 shown as a dashed arrow, reflecting off surfaces in the thick-scintillator 103 and the thin-scintillator 102, finally being detected by the light sensor 104. To be specific, in this example the converter layer 101 is a 1.5-micron layer of natural boron, the thin-scintillator 102 is a 5-micron layer of CaF₂(Eu), the thick-scintillator 103 is a 2 cm thick PVT-based plastic scintillator, and the light sensor 104 is a photomultiplier tube.

Neutron-capture events and gamma ray events are discriminated on the basis of the light pulse shape. Signals from a CaF₂(Eu) scintillator are about 900 ns long, versus the fast 2-5 ns pulses from a plastic scintillator. Alternatively, the thick-scintillator 103 could be a lithium-free glass which has a pulse duration of about 50-100 ns. The glass pulse duration is sufficiently different from the CaF₂ pulse that the neutron and gamma events may be separated reliably. The plastic thick-scintillator detects both gamma rays and high-energy neutron scattering events, whereas the glass thick-scintillator counts only gammas, since the glass is non-hydrogenous.

Again it is emphasized that the sketch is not to scale. The thick-scintillator 103 is shown at about realistic thickness, but the converter layer 101 and the thin-scintillator 102 are in reality much, much thinner than shown in this sketch. In a real embodiment, the converter layer 101 and the thin-scintillator 102 would not be visible if the sketch were drawn to scale. A detector sitting on a workbench would appear to be simply a piece of plastic scintillator, with just a surface discoloration region corresponding to the converter and thin-scintillator. The thin layers are so thin they would not be visible when viewed edge-on. For visibility, then, the converter layer 101 and the thin-scintillator 102 are drawn about 1000 times thicker than they would be in an actual detector.

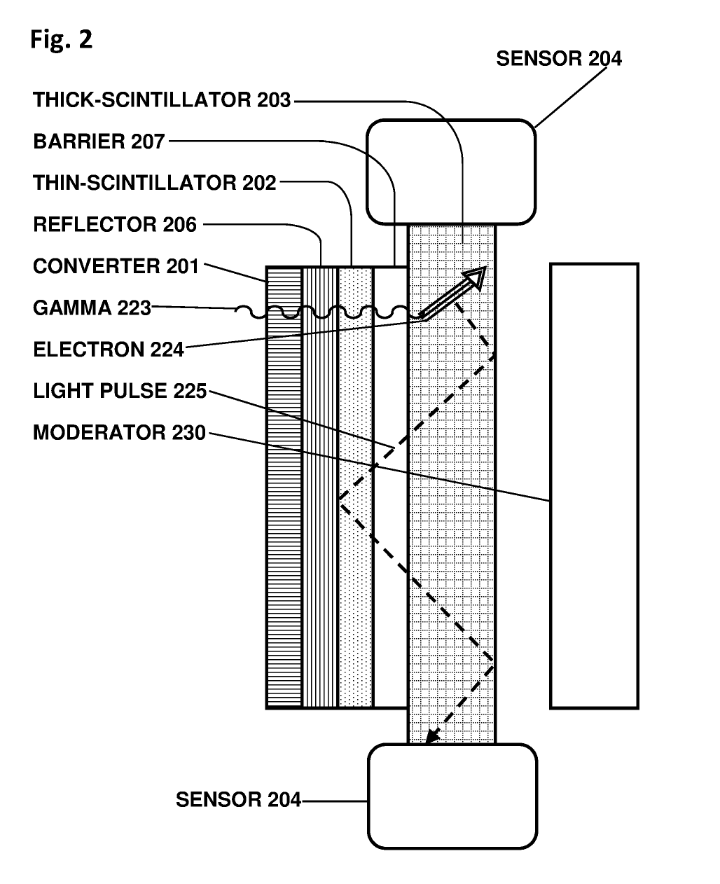

FIG. 2 shows another embodiment of the inventive single-sided detector, but now with extra layers added. A thin-scintillator 202 is deposited onto a barrier layer 207 which is applied to a thick-scintillator 203. Then a reflective layer 206 is deposited onto the thin-scintillator 202, and a converter 201 is deposited over the reflector 206. Two light sensors 204 are then coupled to the thick-scintillator, and an optional neutron moderator 230 is positioned near the detector to thermalize high-energy neutrons.

The sketch depicts a gamma ray 223 which passes through various layers and then Compton scatters in the thick-scintillator 203, thereby producing a Compton-scattered energetic electron 224. The electron 223 travels through the thick-scintillator 203 producing scintillation light 225, which reaches the light sensors 204 after multiple reflections from the surfaces of the reflector 206 and the thick-scintillator 203. The thick-scintillator light 225 is different from the thin-scintillator light 125 in some detectable way, such as pulse shape, so that the incident particle can be identified according to the resulting signal.

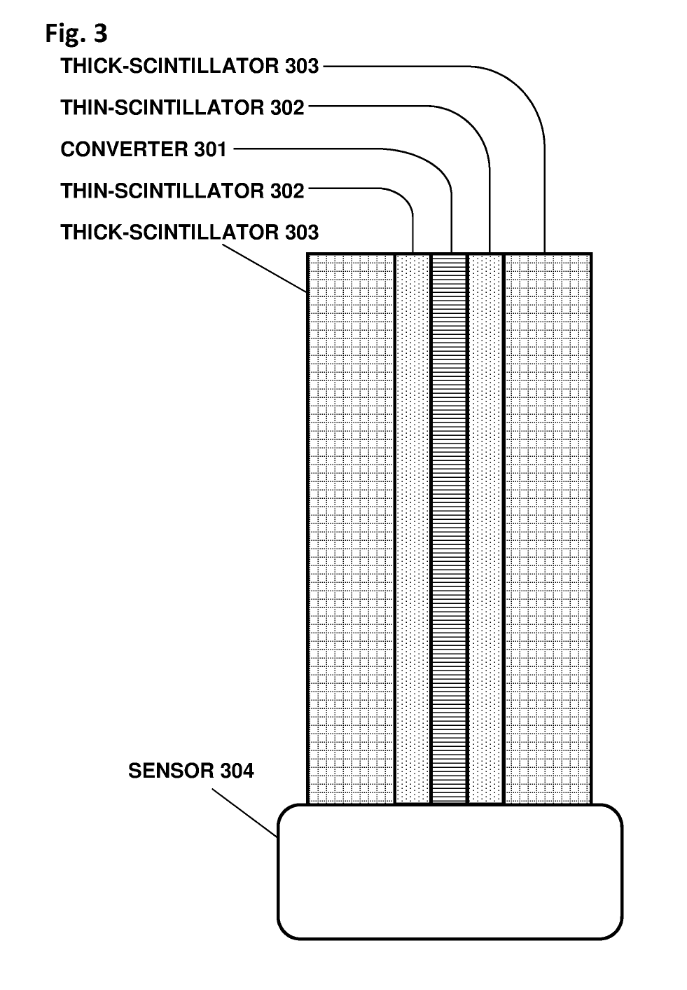

FIG. 3 shows a version of the inventive detector in the “double-thick” configuration, which has about twice the neutron detection efficiency as the single-sided version of FIGS. 1 and 2. Here a thin converter 301 is flanked by two thin-scintillators 302, which are optically coupled to two thick-scintillators 303, which are coupled to a light sensor 304. Neutrons can be captured in the converter 301, which emits energetic ions (not shown) that escape from either side of the converter 301. The ions stop in one of the thin-scintillators 302, thereby enabling detection from both sides of the converter 301.

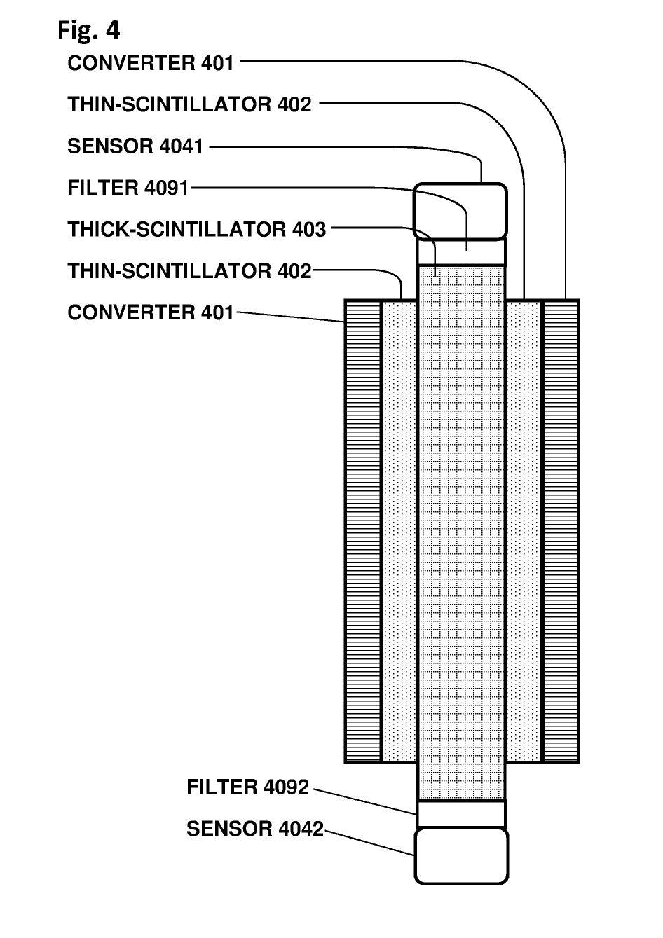

FIG. 4 shows an embodiment of the “double-converter” configuration of the invention, with wavelength discrimination. Here a single thick-scintillator 403 is coated on both sides by two thin-scintillator layers 402, which are then coated with two thin converters 401. The thick-scintillator 403 is coupled to two light sensors 4041 and 4042, through two optical filters 4091 and 4092 respectively. In this example, the thick-scintillator 403 and the thin-scintillators 402 produce light in different wavelength bands. The filters 4091 and 4092 are highpass and lowpass filters respectively, with passbands arranged to pass only the light of the thick-scintillator 403 or the thin-scintillators 402 respectively. The filters 4091 and 4092 may be chemical type filters which absorb the out-of-band light, or they may be dichroic type filters that reflect the out-of-band light back toward the other sensor. The sensors 4041 and 4042 may be of the same type, or they may have different properties to more closely match the particular wavelength ranges that they detect. For example, the two sensors 4041 and 4042 could be different types wherein each sensor is intrinsically sensitive only to the light of one of the scintillators (such as a blue-sensitive phototube to detect short wavelengths and a red-sensitive photodiode to detect long wavelengths), thereby performing the wavelength discrimination without the need for the filters 4091 and 4092 at all.

The double-converter configuration is economical and practical since the neutron detection efficiency is nearly doubled, relative to the single-sided case, with just the addition of a second thin-scintillator coating and a second converter coating. It is also compact and rugged, although a protective coating may be needed over each of the converters 401.

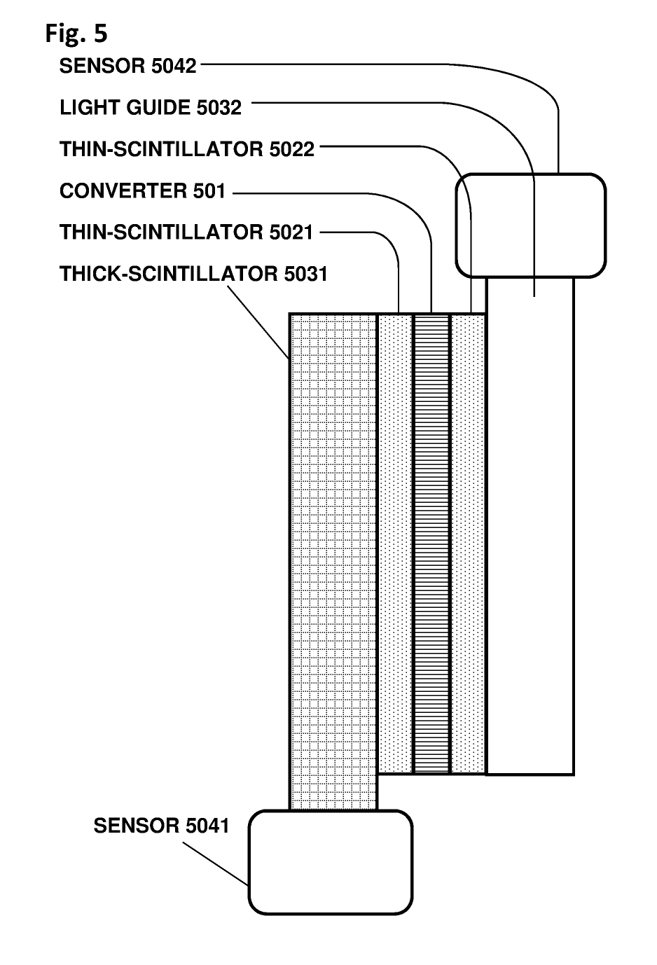

FIG. 5 shows a detector of the inventive double-thick configuration but with one of the thick-scintillators replaced by a non-scintillating light guide. Thin layers are greatly expanded. Here a central converter 501 is flanked by two thin-scintillators 5021 and 5022, which are optically coupled to a thick-scintillator 5031 and a transparent non-scintillating light guide 5032. The thick-scintillator 5031 is optically coupled to a first sensor 5041, and the non-scintillating light guide 5032 is coupled to a second sensor 5042.

The sensors 5041 and 5042 provide two data streams corresponding to different particle interactions. Signals from the first sensor 5041 include the thin-scintillator 5021 pulses that indicate neutron-capture events, plus the thick-scintillator 5031 pulses that indicate gamma ray events. If the thick-scintillator 5031 is hydrogenous, the high-energy proton-recoil events would also appear in the signals from sensor 5041 as thick-scintillator type pulses. In contrast, the signals from the second sensor 5042 include only the low-energy neutron-capture events seen by the thin-scintillator 5022. The data from sensor 5042 includes no gamma events or proton recoil events because the non-scintillating light guide 5032 produces no light, and the thin-scintillator 5022 is far too thin to detect gamma-generated electrons. Thus the signals from the second sensor 5042 comprise an extremely background-free measure of the low-energy neutron flux, with no interference from gammas. If the non-scintillating light guide 5032 is hydrogenous, then very rarely a recoil proton may intersect the thin-scintillator 5022 and contribute to the neutron signal; but if the light guide 5032 is non-hydrogenous then even those rare events are eliminated. Thus the signals from sensor 5042 are extremely background-free. As an added bonus, the gamma ray flux can be evaluated by subtracting the detection rate of the second sensor 4042 from the first sensor 4041. As a further option, the light guide 5032 can serve as a neutron moderator if the light guide 5032 comprises hydrogen, thereby further enhancing the neutron detection efficiency.

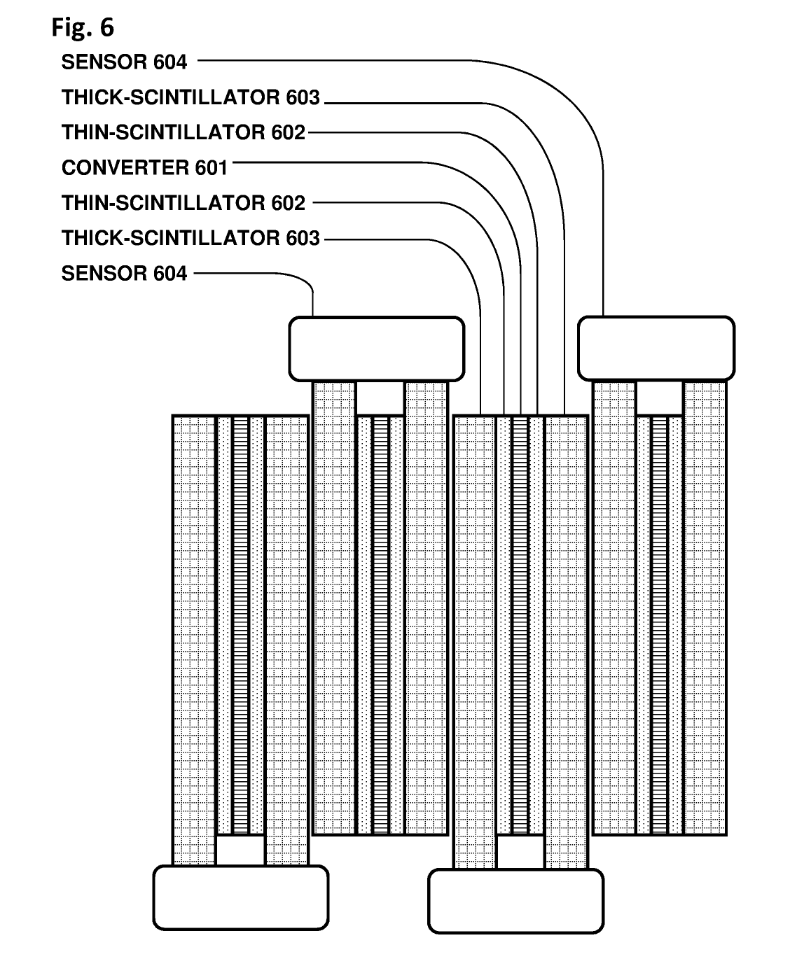

FIG. 6 shows a stack of four of the inventive detectors, each being the double-thick configuration. The thin layers are shown greatly expanded. Although only four detector modules are shown, in practice any number of detectors can be put together in this way. Only one module is labeled for clarity; the others are identical. Each detector includes a converter 601, surrounded by two thin-scintillators 602, which are optically coupled to two thick-scintillators 603, which are optically coupled to a light sensor 604.

An advantage of stacking multiple detectors in this way is that the neutron detection efficiency is substantially higher than for a single detector. It is usually said that the detection efficiency of a stack of N detectors increases with additional layers, but is always less than N times the efficiency of a single detector. In this case, however, the effective detection efficiency may increase faster than N, because the thick-scintillators 603 could serve as neutron moderators (if hydrogenous) thereby converting high-energy neutrons into detectable low-energy neutrons. The detection rate would then increase substantially with each additional layer, continuing until there are enough layers to fully thermalize the incident neutron flux.

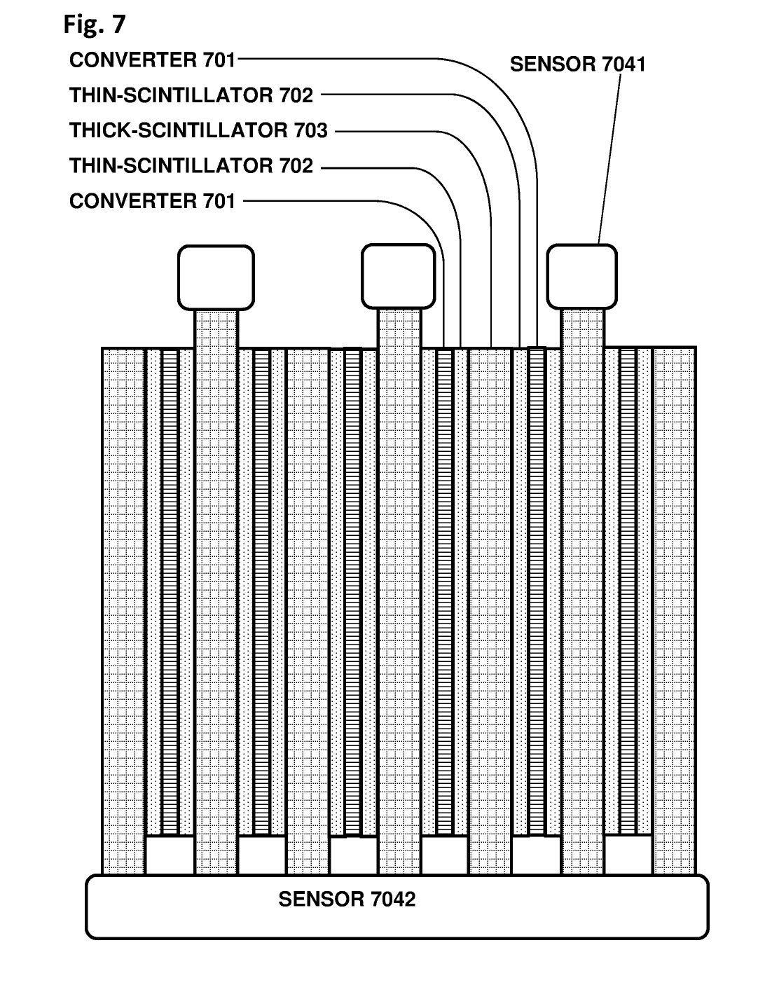

FIG. 7 is a sketch showing another stack configuration according to the invention, but here using shared light guides between each pair of detectors. Again only one module is labeled for clarity, and the thin layers are greatly expanded. A thick-scintillator 703 is optically coupled to two thin-scintillators 702 which are proximate to two converters 701. Two different sensor arrangements are shown. Sensors 7041 are coupled to only one of the thick-scintillators 703, thereby providing an indication of which layer a neutron or gamma ray interacted in. Alternatively, a ganged sensor 7042 is optically coupled to multiple thick-scintillators 703, thereby providing a detection signal whenever a neutron or gamma ray has interacted anywhere in the stack. Depending on the information needs of the application, separate sensors 7041 or a ganged sensor 7042 may be most appropriate. Also the ganged sensor 7042 is usually more economical than having multiple separate sensors 7041.

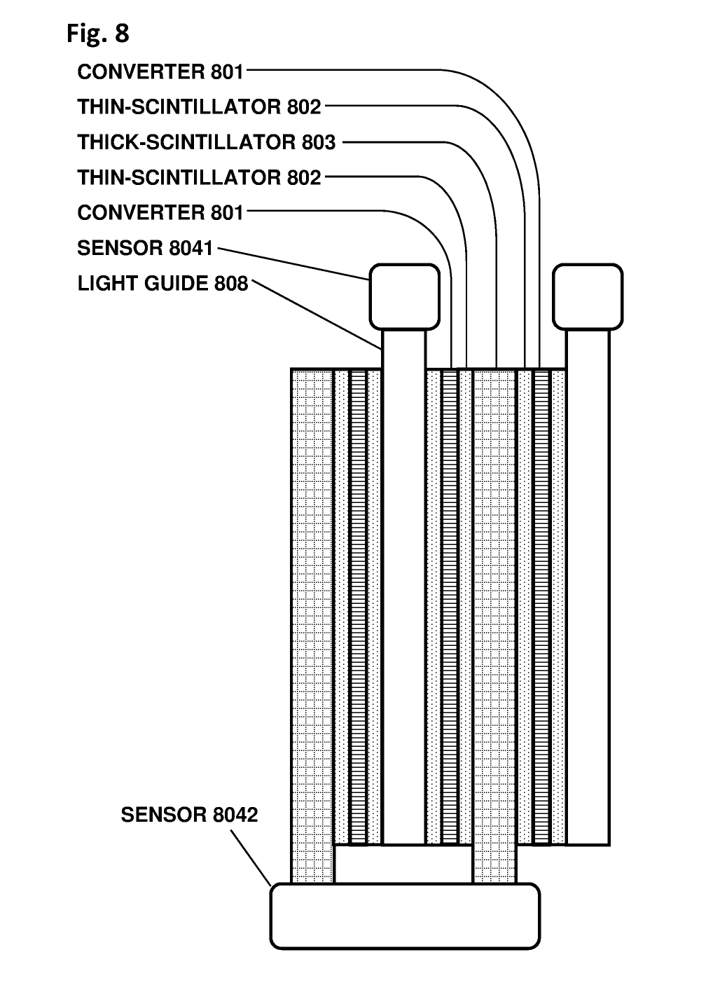

FIG. 8 is another version of the inventive detector stack, based on the version of FIG. 7, but with alternate thick-scintillators replaced by non-scintillating light guides. Again, the thin layers are highly exaggerated in the sketch, and only one module is labeled.

Each converter 801 is flanked by two thin-scintillators 802, which are coupled to either a thick-scintillator 803 or a transparent light-guide 808. The thick-scintillators 803 are coupled to a ganged light sensor 8042, while the light guides 808 are coupled to individual light sensors 8041. Signals from the ganged thick-scintillator light sensor 8042 thus detect both low-energy neutrons and gamma rays (discriminated with different pulse shapes), whereas the separate light-guide light sensors 8041 detect only low-energy neutrons and have practically zero background. A detector stack according to FIG. 8 would provide a rich multi-parameter data stream for radiation from any inspection item at a border crossing for example.

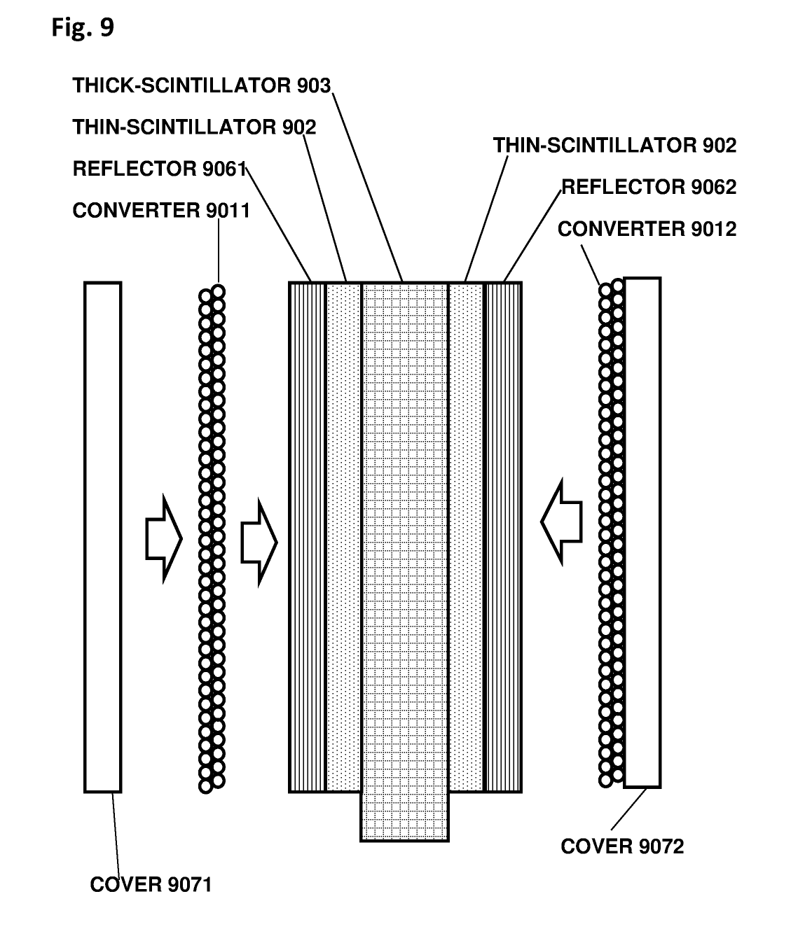

FIG. 9 is a sketch of the inventive detector in the double-converter configuration, but now with powder type converters and optional covers. The sketch suggests two different ways the converters can be applied.

A central thick-scintillator 903 is optically coupled to two thin-scintillators 902 which are covered by reflector layers 9061 and 9062. A first powder converter 9011 is deposited on one of the reflective layers 9061, and then a protective cover 9071 is attached over the powder converter 9011 to protect it, since powder deposits are usually quite fragile. As an alternative variation, a second powder converter 9012 is deposited directly on the second cover 9072, which is then secured onto the assembly with the second converter 9012 proximate to the second reflector 9062.

An advantage of the first method is that the powder converter 9011 can be directly deposited on the reflector 9061 without damaging the thin-scintillator 902, since no harsh chemicals or high temperatures are involved (although some heating may be needed to set a binder). An advantage of the second method is that the powder converter 9012, after being deposited on the cover 9072, can be inspected to eliminate defective deposits. It may also be tested with a neutron source to ensure uniform coverage and proper thickness. The advantage of doing so is that it is easier to repair or discard a defective converter that is separate and accessible on a cover plate, rather than trying to clean off a converter that is already deposited onto the thin-scintillator.

The double-converter configuration is economical since only one thick-scintillator 903 is required. A further advantage is that the low-energy neutron detection efficiency is about doubled, relative to the single-sided configuration, with no increase in the gamma ray detection rate. This is particularly an advantage when neutron detection is required, and when the background is mainly gammas, which is generally the case for vehicle inspections.

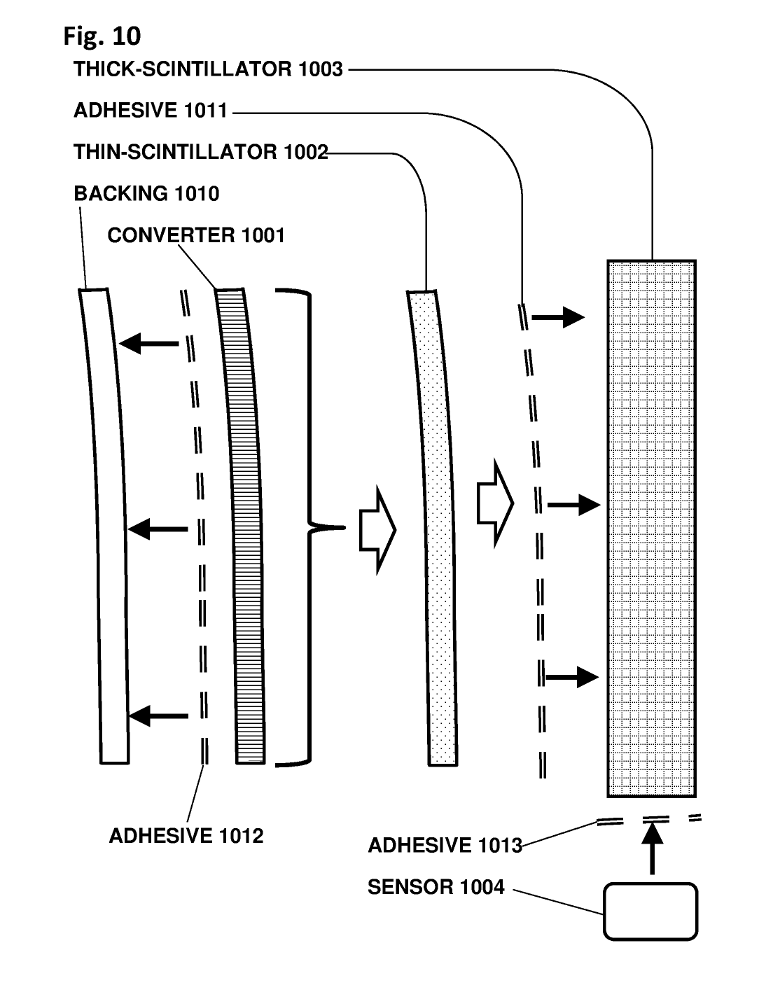

FIG. 10 is an exploded assembly view of the inventive single-sided detector, but using a precast film scintillator and thin foil type converter. The thick-scintillator 1003 is prepared by applying an adhesive 1011, shown as a doubledash curve, to the thick-scintillator 1003, and then applying the precast thin-scintillator 1002 film, preferably with a roller (not shown). The thin components are shown as curved sheets in the sketch to indicate that they are flexible foils and films, not rigid deposits.

An adhesive 1012 is then applied to the backing sheet 1010, and the boron thin foil converter 1001 is attached to the backing sheet 1010. Then the converter 1001 and backing 1010 assembly is mounted onto the rest of the detector, with the foil converter 1001 proximate to the thin-scintillator 1002. Finally the sensor 1004 is attached to the thick-scintillator 1003 using another adhesive 1013. By preparing all of the thin layers as films in advance, expensive deposition steps are avoided, thereby making it feasible to build a large-area detector quickly and cheaply. Also any damage to the underlying layers is obviated since no harsh chemicals or high temperatures are involved in assembling the detector.

As an alternative, the adhesive 1011 could be applied to the thin-scintillator 1002 instead of the thick-scintillator 1003, and the foil converter 1001 could be applied directly to the thin-scintillator 1002, with the backing 1010 being applied later as a protective cover. Alternatively, the second adhesive 1012 could be applied to the foil converter 1001, for example as an aerosol, before the converter 1001 is rolled on. Or, the converter 1001 could be attached directly to the thin-scintillator 1002 using electrostatic attraction or with an extremely thin (preferably molecular monolayer) adhesive, in which case the backing 1010 may or may not be needed.

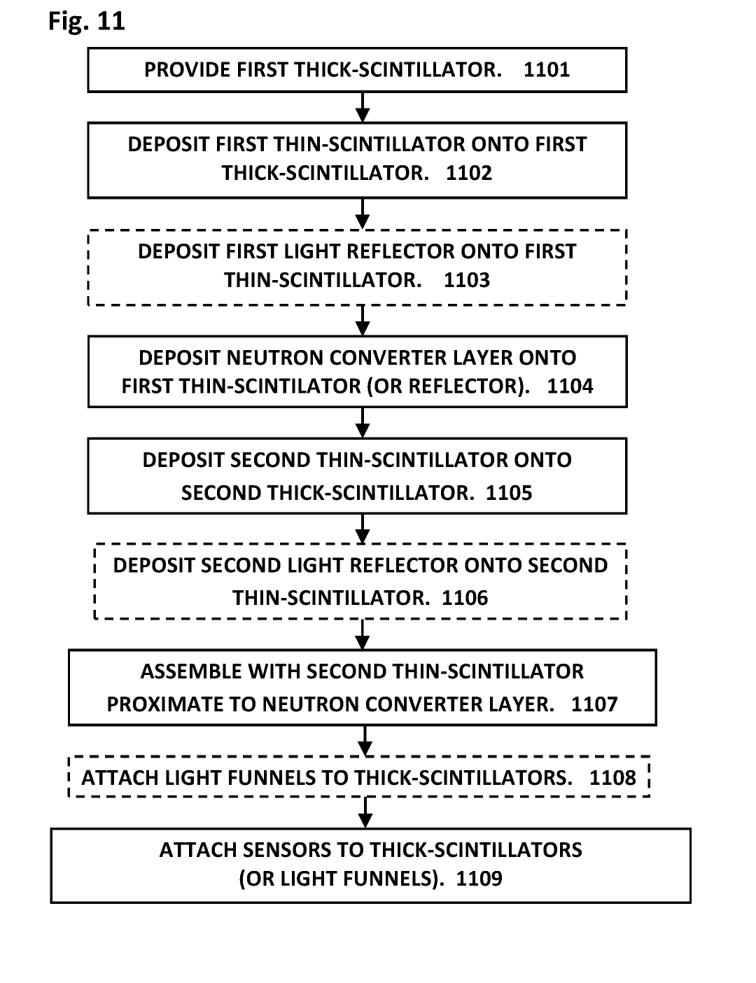

FIG. 11 is a flowchart showing how the inventive detector may be assembled in the double-thick configuration of FIG. 3, or as one module of the stack of FIG. 6. A first thick-scintillator is prepared 1101, such as a flat sheet of plastic scintillator, preferably with polished edges. Then, the first thin-scintillator is deposited on the first thick-scintillator at 1102. The first thin-scintillator deposition is controlled to produce a thin layer of material with a desired thickness, typically a few microns to a few tens of microns depending on the neutron reaction planned (that is, boron versus lithium). Optionally (shown in dash), a first light reflector may be deposited onto the first thin-scintillator at 1103 to enhance light transmission.

Then at 1104 the converter material is deposited on the first thin-scintillator (or on the first light reflector material if present). The other half of the detector is then prepared in a similar fashion. Starting with a second thick-scintillator, the second thin-scintillator is deposited on it at 1105, and optionally the second light reflector is deposited on the second thin-scintillator at 1106. Then the two parts are pressed together at 1107 with the converter layer proximate to the second thin-scintillator layer (or the second light reflector). Then, if light funnels are to be used, they are applied to the thick-scintillators at step 1108 (if not already mounted). Finally, the light sensor or sensors are attached at 1109 to the thick-scintillators (or to the light funnels if present).

As a further alternative, a barrier layer may be applied to the first thick-scintillator after step 1101, and also to the second thick-scintillator before step 1105, to prevent ions from reaching the thick-scintillator. The barrier would not be necessary if the thin-scintillators were made thick enough to stop the ions, but if the thin-scintillator thickness is less than the maximum ion stopping range (to minimize the light from gamma-generated electrons for example) then barrier layers are recommended to prevent ions from reaching the thick-scintillator. Also, a barrier layer may be needed simply to protect the thick-scintillator material from damage during the thin-scintillator deposition process.

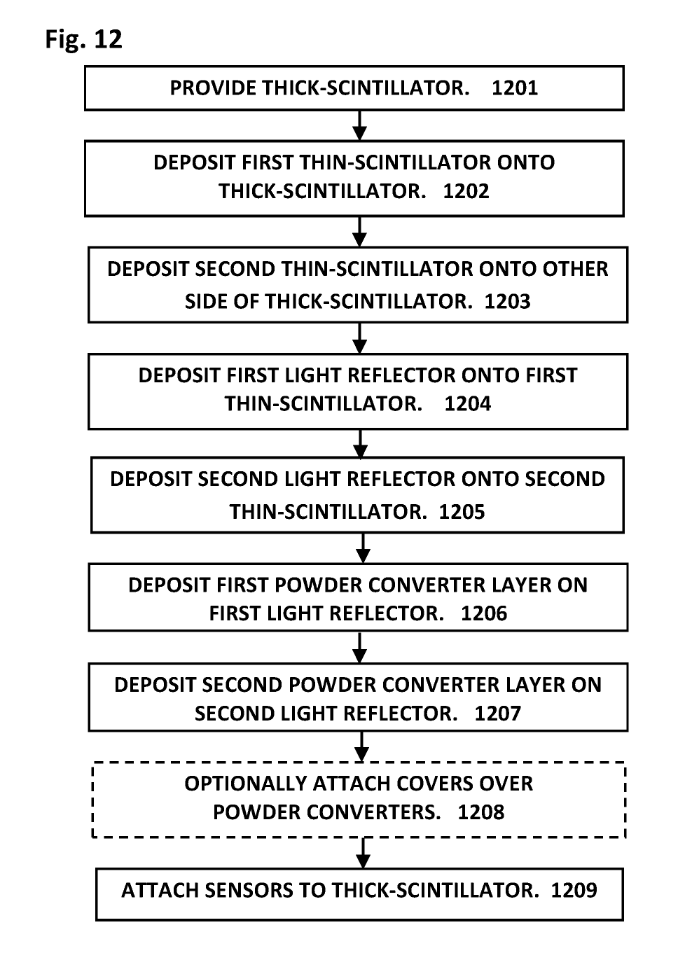

FIG. 12 is a flowchart showing steps of the inventive method to produce a double-converter configuration detector with powder-type converters, such as that of FIG. 9. First a thick-scintillator is prepared at 1201, then the first thin-scintillator is deposited on it at 1202, and the second thin-scintillator is deposited on the other side of the thick-scintillator at 1203. Then light reflecting layers are deposited on both thin-scintillators at 1204 and 1205. The first powder converter is then laid down onto the first reflector at 1206, and the second powder converter is deposited on the second reflector at 1207. Optionally, protective covers may be attached over the converters at 1208. Finally at 1209 the sensor or sensors are attached to the thick-scintillator.

The powder converter may be deposited using a gas-entrainment jet, preferably with electrostatic assist to minimize loft losses, as is known in the art. Optionally, the powder converters may be deposited onto the protective covers first, and these are then pressed onto the reflective layers thereafter. The advantage of the latter is that the powder converters can be inspected or tested while still accessible, and a poor deposition may be discarded. As a further option, the powder may include a small amount of heat-set binder, and the entire detector may then be pressed and heated to solidify the converters, although being careful not to dent the thin-scintillator.

The invention with its many options disclosed herein will help prevent nuclear terrorism. The detector will enable full-surround vehicle inspections with sufficient sensitivity to detect even well-shielded nuclear material. In a walk-through portal, the invention will alarm upon trace amounts of radioactive material on personnel. In a hand-held survey instrument application, the invention will provide fast, information-rich data to help inspectors detect and localize radioactive sources, particularly weapon-grade materials, even in small quantities. With the inventive detectors, it will be technically and economically feasible to inspect all cargo passing through ports and border crossings for the first time. The inventive detector detects sparse radiation including that escaping from a well-shielded nuclear threat, and provides signals rich with information about the threat. As an area detector, the inventive detector can be straightforwardly scaled up to virtually any size, thereby ensuring weapon detection.

The embodiments and examples provided herein illustrate the principles of the invention and its practical application, thereby enabling one of ordinary skill in the art to best utilize the invention. Many other variations and modifications and other uses will become apparent to those skilled in the art, without departing from the scope of the invention, which is to be defined by the appended claims.

1. A device comprising:
a converter comprising nuclei that capture a neutron and responsively emit an ion;
a thin-scintillator comprising a transparent material that emits a first light pulse when traversed by a charged particle;
a thick-scintillator comprising a transparent material that emits a second light pulse, different from the first light pulse, when traversed by a charged particle; and
a light sensor comprising a transducer that produces an electronic signal related to a light pulse;
wherein:
the converter comprises a substantially planar layer having a thickness related to the stopping range of the ion therein;
the thin-scintillator comprises a substantially planar layer, separate from the converter, having a thickness related to the stopping range of the ion therein;
the thin-scintillator is proximate to the converter;
the thick-scintillator is optically coupled to the thin-scintillator;
the light sensor is optically coupled to the thick-scintillator;
the thin-scintillator is configured to prevent the ion from passing into the thick-scintillator;
the thin-scintillator is substantially transparent to the first and second light pulses; and
the thick-scintillator is substantially transparent to the first and second light pulses.

2. The device of claim 1, wherein:
the converter thickness is 0.2 to 2.0 times the stopping range of the ion in the converter material;
the thin-scintillator thickness is substantially equal to the stopping range of the ion in the thin-scintillator material;
the thick-scintillator has a thickness of 5 to 26 mm; and
the thin-scintillator is configured to produce at least 50 times more scintillation photons, when traversed orthogonally by a 1.3 MeV triton, than when traversed orthogonally by a 1 MeV electron.

3. The device of claim 1, wherein:
the converter layer has two lateral dimensions that are each at least 1000 times the thickness of the converter layer;
the thin-scintillator layer has two lateral dimensions that are each at least 1000 times the thickness of the thin-scintillator layer;
the thick-scintillator has a thickness of at least 200 times the thickness of the thin-scintillator;
the device includes a transparent non-scintillating barrier layer between the thin-scintillator and the thick-scintillator;
the thin-scintillator thickness is at most equal to the stopping range of the ion therein; and
the thickness of the barrier and the thin-scintillator together is at least equal to the stopping range of the ion.

4. The device of claim 1, wherein:
the device further comprises a second thin-scintillator and a second thick-scintillator;
the second thin-scintillator comprises substantially the same material as the thin-scintillator of claim 1;
the second thin-scintillator is proximate to the converter;
the second thick-scintillator is optically coupled to the second thin-scintillator and to a second light sensor;
the thick-scintillator of claim 1 substantially comprises hydrogen; and
the second thick-scintillator is substantially hydrogen-free.

5. The device of claim 1, wherein:
the thick-scintillator is a hydrogenous polymer comprising a fluor;
the fluor of the thick-scintillator emits detectably different light pulses according to whether a proton or an electron passes therein; and
the device includes electronics configured to determine, from the electrical signal, whether a low-energy neutron, a high-energy neutron, or a gamma ray is detected.

6. The device of claim 1, wherein:
the device further comprises a reflective layer between the converter and the thin-scintillator;
the reflective layer is separate from the converter layer and separate from the thin-scintillator layer; and
the reflective layer is configured to substantially allow the ion to pass from the converter into the thin-scintillator.

7. The device of claim 1, wherein:
the device further comprises a transparent non-scintillating layer between the thin-scintillator and the thick-scintillator;
the non-scintillating layer is configured to prevent the ion from passing into the thick-scintillator;
the non-scintillating layer is configured to convey, with substantially zero attenuation, scintillation photons from the thin-scintillator into the thick-scintillator; and
the non-scintillating layer is configured to convey, with substantially zero attenuation, scintillation photons from the thick-scintillator into the thin-scintillator.

8. The device of claim 1, further comprising:
a first optical filter configured to substantially pass the first light pulse and to substantially reflect the second light pulse;
a second optical filter configured to substantially pass the second light pulse and to substantially reflect the first light pulse;
a first light sensor optically coupled to the first filter and configured to detect light reflected from the second filter; and
a second light sensor optically coupled to the second filter and configured to detect light reflected from the first filter.

9. The device of claim 1, further comprising:
a second thin-scintillator comprising substantially the same material as the thin-scintillator of claim 1;
a non-scintillating transparent light guide optically coupled to the second thin-scintillator;
a second light sensor optically coupled to the non-scintillating transparent light guide; and
electronics configured to determine, from electronic signals of the second light sensor, a neutron detection rate that has substantially zero interference from gamma rays.

10. The device of claim 1, wherein:
the converter comprises a layer deposited onto a protective cover;
the thin-scintillator comprises a precast film which is adhesively attached to the thick-scintillator using an adhesive layer; and
the adhesive layer is configured to prevent the ion from entering the thick-scintillator.

11. The device of claim 1 wherein:
the converter comprises a powder; and
a reflecting layer is positioned between the powder and the thin-scintillator.

12. A system comprising:
a plurality of converters, each converter comprising a substantially planar layer of material that captures a neutron and responsively emits an energetic ion;
a plurality of thin-scintillators, each thin-scintillator comprising a substantially planar layer, separate from the converter layers, of material that emits a first light pulse responsive to traversal by a charged particle, wherein each thin-scintillator is proximate to exactly one of the converters;
a plurality of thick-scintillators, each thick-scintillator comprising a substantially planar transparent body that emits a second light pulse, different from the first light pulse, responsive to traversal by a charged particle, and wherein each thick-scintillator is optically coupled to at least one of the thin-scintillators; and
one or more light sensors, each light sensor being optically coupled to at least one of the thick-scintillators wherein:
each thin-scintillator is configured to prevent the ion from passing into the thick-scintillators;
each thin-scintillator is substantially transparent to the first and second light pulses; and
each thick-scintillator is substantially transparent to the first and second light pulses.

13. The system of claim 12, wherein:
each converter has a thickness that is related to the stopping range of the energetic ion in the converter material;
each thin-scintillator has a thickness that is related to the stopping range of the energetic ion in the thin-scintillator material;
each thick-scintillator has a thickness of 5 to 26 mm;
the system further comprises a plurality of transparent non-scintillating light guides;
each non-scintillating light guide is optically coupled to at least one thin-scintillator;
each non-scintillating light guide is optically coupled to at least one light sensor; and
the system is configured to determine, responsive to a signal associated with the non-scintillating light guides, that a low-energy neutron was detected.

14. A method comprising:
providing a thick-scintillator comprising a substantially planar transparent body that emits a first light pulse responsive to traversal by a charged particle;
optically coupling, to the thick-scintillator, a thin-scintillator comprising a substantially planar layer of material that emits, responsive to traversal by a charged particle, a second light pulse which is different from the first light pulse;
placing, proximate to the thin-scintillator, a converter comprising a substantially planar layer of material that captures a neutron and responsively emits an ion; and
optically coupling a light sensor to the thick-scintillator wherein:
the converter layer is a separate layer from the thin-scintillator layer;
the thin-scintillator is configured to prevent the ion from passing into the thick-scintillator; and
the thin-scintillator and the thick-scintillator are both substantially transparent to the first and second light pulses.

15. The method of claim 14 wherein:
the converter layer has a thickness that is related to the stopping range of the ion in the converter material;
the thin-scintillator layer has a thickness that is related to the stopping range of the ion in the thin-scintillator material;
the thick-scintillator has a thickness of 5 to 26 mm;
the thin-scintillator includes a reflecting layer on a surface of the thin-scintillator opposite to the thick-scintillator;
the reflecting layer is configured to substantially allow the ion to pass through the reflecting layer into the thin-scintillator; and
the converter is attached to the reflecting layer.

16. The method of claim 14, further comprising:
depositing a reflective layer onto the thin-scintillator; and
depositing a powder comprising the converter onto the reflective layer.

17. The method of claim 14, further comprising:
attaching a layer of transparent non-scintillating material between the thick-scintillator and the thin-scintillator, wherein:
the thin-scintillator has a thickness at most equal to the stopping range of the ion; and
the thickness of the thin-scintillator plus the non-scintillating material layer together is at least equal to the stopping range of the ion.

18. The method of claim 14, further comprising:
analyzing electrical signals produced by the light sensor responsive to the light pulses;
determining, responsive to a first electrical signal from the light sensor, that a low-energy neutron was detected;
determining, responsive to a second electrical signal from the light sensor, different from the first electrical signal, that a high energy neutron was detected; and
determining, responsive to a third electrical signal from the light sensor, different from the first and second electrical signals, that a gamma ray was detected wherein:
the thick-scintillator comprises a hydrogenous material that emits different light pulses responsive to traversal by an electron and a recoil proton respectively.

19. The method of claim 14, further comprising:
measuring a pulse shape or a pulse duration associated with signals from the light sensor;
determining, responsive to a first pulse shape or pulse duration, that a low-energy neutron was detected;
when the thick-scintillator substantially comprises hydrogen, determining, responsive to a second pulse shape or pulse duration which is different from the first pulse shape or pulse duration, that a gamma ray or a high-energy neutron was detected; and
when the thick-scintillator is substantially hydrogen-free, determining, responsive to a second pulse shape or pulse duration which is different from the first pulse shape or pulse duration, that a gamma ray was detected.

20. The method of claim 14, further comprising:
attaching, to the thick-scintillator, a first optical filter that admits wavelengths associated with the thin-scintillator and reflects wavelengths associated with the thick-scintillator;
attaching, to the thick-scintillator, a second optical filter that admits wavelengths associated with the thick-scintillator and reflects wavelengths associated with the thin-scintillator;
attaching a first light sensor to the first optical filter; and
attaching a second light sensor to the second light filter.
